(19) United States
(12) Patent Application Publication
(10) Pub. No.: US 2013/0297564 A1
(43) Pub. Date: Nov. 7, 2013

(54) EVENT-BASED RECORDS MANAGEMENT

(71) Applicant: GREATCALL, INC., San Diego, CA (US)

(72) Inventors: Scott Brenton, San Diego, CA (US); Krijn van der Raadt, San Diego, CA (US); Kalin Gyokov, San Diego, CA (US)

(73) Assignee: GREATCALL, INC., San Diego, CA (US)

(21) Appl. No.: 13/889,086

(22) Filed: May 7, 2013

Related U.S. Application Data
(60) Provisional application No. 61/643,889, filed on May 7, 2012.

(51) Int. Cl. G06F 17/30

(52) U.S. Cl. CPC G06F 17/30581
USPC 707/634

(57) ABSTRACT

Systems and methods of managing operational records, for example of a private response center. In one implementation the system includes one or more processors, memory holding instructions executable by the one or more processors, distributed storage holding a plurality of event stores storing records of events, and one or more electronic communication links between locations at which the event stores are stored. The instructions, when executed by the one or more processors, cause the system to receive a request for a view of a state of the system, and construct the view from the records in at least one of the event stores.

### CROSS-REFERENCE TO RELATED APPLICATIONS

This application claims the benefit of U.S. Provisional Patent Application No. 61/643,889 filed May 7, 2012 and titled “Event-Based Records Management”, the entire disclosure of which is hereby incorporated by reference herein.

### BACKGROUND OF THE INVENTION

In many environments, robust records management is highly desirable. Preferably, a records management system should be scalable, should function effectively in times of data network outage, and should enable accurate data recovery.

### BRIEF SUMMARY OF THE INVENTION

According to one aspect, a system for managing operational records includes one or more processors, memory holding instructions executable by the one or more processors, distributed storage holding a plurality of event stores storing records of events, and one or more electronic communication links between locations at which the event stores are stored. The instructions, when executed by the one or more processors, cause the system to receive a request for a view of a state of the system, and construct the view from the records in at least one of the event stores. In some embodiments, the events include calls by clients of a private response center requesting assistance from the private response center. In some embodiments, the instructions, when executed by the one or more processors, further cause the system to synchronize the event stores to reflect changes made at one of the event stores such that eventually a view resulting from a request made at any of the event stores will be consistent with a view resulting from a like request made at any other of the event stores. In some embodiments, upon receipt of a write of a new event record to the event stores, the event is applied to any affected views. In some embodiments, events are applied to affected views in conjunction with constructing a snapshot of a state of the event stores. In some embodiments, the instructions, when executed by the one or more processors, further cause the system to construct a snapshot of a state of the event stores. In some embodiments, the instructions, when executed by the one or more processors, further cause the system to construct the requested view in relation to the most recent snapshot.

According to another aspect, a method of maintaining records of events includes maintaining in distributed storage a plurality of computerized event stores storing records of events in a non-hierarchical list, and constructing views of the records in the event stores in response to view requests. The method further includes synchronizing the event stores, via electronic messages sent over a data network, to reflect changes made at one of the event stores such that eventually a view resulting from a request made at any of the event stores will be consistent with a view resulting from a like request made at any other of the event stores. The method may further include applying an event record to an affected view upon receipt of a write of the new event record to the event stores. In some embodiments, the method further includes periodically preparing a snapshot of the state of an aspect of the event records in the event stores. In some embodiments, the method further includes applying an event record to an affected view in conjunction with constructing a snapshot of an aspect of the event records in the event stores. The method may further include auditing a state of the event stores by reconstructing the state from event records in the event stores. In some embodiments, the method further includes receiving event records independently at one of the event stores during a time when network connectivity is lost between the event stores, and when network connectivity is restored, synchronizing the event records in the event stores. In some embodiments, the constructing views of the records in the event stores comprises constructing a view that includes a listing of event records from the event stores. In some embodiments, constructing views of the records in the event stores comprises constructing a view that includes state information derived from event records in the event stores. The method may further include grouping related events in the event stores into incidents.

According to another aspect, a system for managing records includes one or more processors, memory holding instructions executable by the one or more processors, distributed storage holding a plurality of event stores storing records of events in a non-hierarchical list, and an electronic network connecting the distributed event stores. The instructions, when executed by the one or more processors, cause the system to receive a request for a view of a state of the system, construct the view from the records in at least one of the event stores, receive at one of the event stores a record of a new event, and synchronize the event stores to reflect the new event such that eventually a view resulting from a request made at any of the event stores will be consistent with a view resulting from a like request made at any other of the event stores. In some embodiments, the event stores are synchronized upon receipt of the new event record. In some embodiments, the event stores are synchronized in conjunction with constructing a snapshot of the state of an aspect of the event records in the event stores. In some embodiments, no event records are deleted from the event stores.

### BRIEF DESCRIPTION OF THE DRAWINGS

FIG. 1 illustrates a simplified schematic of a system according to embodiments of the invention.

FIG. 2 illustrates a visual representation of a system as a sequence of events, in accordance with embodiments.

FIGS. 3A and 3B illustrate two example arrangements of distributed storage, according to embodiments of the invention.

FIGS. 4A-4C illustrate the concept of eventual consistency, in accordance with embodiments of the invention.

FIG. 5 illustrates a conceptual view of certain operational aspects of the system of FIG. 1.

FIG. 6 shows a sequence diagram illustrating in more detail how two objects work to provide consistency, in accordance with embodiments of the invention.

FIG. 7 illustrates an event-based aspect of the system of FIG. 1.

FIG. 8 is a block diagram illustrating an exemplary computer system usable in embodiments of the invention.

### DETAILED DESCRIPTION OF THE INVENTION

The ensuing description provides preferred example embodiment(s) only, and is not intended to limit the scope, applicability or configuration of the disclosure. Rather, the ensuing description of the preferred example embodiment(s) will provide those skilled in the art with an enabling description for implementing a preferred example embodiment. It is understood that various changes may be made in the function and arrangement of elements without departing from the spirit and scope as set forth in the appended claims.

Specific details are given in the following description to provide a thorough understanding of the embodiments. However, it will be understood by one of ordinary skill in the art that the embodiments may be practiced without these specific details. For example, systems, structures, and other components may be shown as components in block diagram form in order not to obscure the embodiments in unnecessary detail. In other instances, well-known processes, procedures and techniques may be shown without unnecessary detail in order to avoid obscuring the embodiments.

Also, it is noted that individual embodiments may be described as a process which is depicted as a flowchart, a flow diagram, a structure diagram, or a block diagram. Although a flowchart may describe the operations as a sequential process, many of the operations may be performed in parallel or concurrently. In addition, the order of the operations may be re-arranged. A process may be terminated when its operations are completed, but could have additional steps not included in a figure. Furthermore, embodiments may be implemented by manual techniques, automatic techniques, or any combination thereof

Embodiments of the invention may find application in a customer service environment, in which robust records management is highly desirable. In one example environment, a private response center may accept calls for assistance from clients. For example, the private response center may be operated by a service provider who offers personalized assistance to clients who subscribe to the service. In some embodiments, the service provider may offer personal health management advice, concierge services, navigational assistance, technical support for telephones used in conjunction with the service, or other kinds of personalized services deliverable by telephone. The private response center may be staffed by customer service representatives who answer inquiries from clients of the service. Such a service may especially appeal to clients with health or other impairments. For example, the service could include weekly or daily calls to the client for verification that the client is doing well, and if not, the customer service representative may offer to contact a family member, health care provider, or other resource that may be helpful to the client. The service could include these and other services sold as a package.

The private response center is not intended to be a substitute for a public safety answering point such as a 911 emergency number. A client of the service offered by the private response center would still be expected to dial 911 (or the appropriate other number in his or her location) in the event of an emergency. However, the service provider who operates the private response center may still wish to provide assistance to the client, in conjunction with the emergency, of a kind not normally provided by the 911 system. For example, the service provider may be available to contact family members of the client to notify them of the emergency. The service provider may also maintain a profile for each client, containing information that may be helpful to the client in relation to the emergency, for example a list of medications currently being taken by the client. The private response center may also be completely automated and provided via an internet or similar service.

In one example scenario, the service provider that operates the private response center may also be a cellular telephone service provider, and may offer a private assistance service as an adjunct to cellular telephone service. The private response center may be contacted for non-emergency service through a phone number, speed dial or other shortcut, for example by activating a 5 and * key combination. In some embodiments, a client may carry a specially-programmed cellular phone or other communicator that periodically determines its geographical location using global positioning system (GPS) information, information received from the cellular network, other kinds of location information, or combinations location information. The device can report its location to the private response center when a call is made or at other times, so that the private response center can better assist the client in an urgent situation. The reported location may also be called a position fix. More information about a private response center in accordance with embodiments may be found in the following U.S. patent applications, the entire disclosures of which are hereby incorporated by reference herein: U.S. patent application Ser. No. 13/004,481, filed Jan. 11, 2011 and titled “Emergency Call Redirection Systems and Methods”, U.S. patent application Ser. No. 13/004,612, filed Jan. 11, 2011 and titled “Emergency Call Return Systems and Methods”, U.S. patent application Ser. No. 12/981,822, filed Dec. 20, 2010 and titled “Extended Emergency Notification Systems and Methods”, U.S. patent application Ser. No. 13/026,158, filed Feb. 11, 2011 and titled “Systems and Methods for Identifying Caller Locations”, and U.S. patent application Ser. No. 13/286,593, filed Nov. 1, 2011 and titled “Emergency Mobile Notification Handling.”

The operation of such a private response center involves many records, for example clients' profile and account information, records of calls made by clients to the private response center, and other kinds of records. The private response center, while appearing to clients as a single entity, may actually utilize multiple call centers in different geographical locations. It is desirable that the information logged by one location be available to any other locations. For example, if a call to the private response center is accidentally interrupted and the client re-dials the private response center, the second call may not be answered by a customer service representative in the same geographical location as the representative who handled the first call. It is desirable that records of the first call be available to the second customer service representative, so that assistance to the client is as seamless as possible.

In order to enable this functionality most effectively, the call centers should preferably meet several competing goals. For example, the call centers should preferably be able to operate independently, but also in a distributed way. In addition, they should preferably be able to not only to operate at the same time, but also operate on the same data stream. In addition, they should preferably be implemented in a fashion that does not hinder system performance. Finally, they should preferably be able to guarantee data integrity especially with multiple sites simultaneously accessing the same data.

Having call centers geographically dispersed is beneficial for emergency situations. However, despite being geographically dispersed, call centers preferably can work both in isolation (disconnected states) as well as in connected states. Having information available locally would be advantageous in disaster or failure situations, since a network or internet failure would constitute a single point of failure for all call centers. Therefore local infrastructure in each call center ideally may have an up-to-date copy of all information related to a client. This local information may make the system tolerant to the loss of network connectivity, so that if a network connection is broken, the system can continue to function uninhibited. However, once the network connection is re-established, information stored locally may be made available and synchronized across different sites.

Preferably, multiple call centers can operate on the same data stream. For example, in an emergency situation, real time information is crucial. Being able to share real time location updates, profile information, map information, dashboard and real time customer, environmental, situational, and relational data may make a key difference in the safety of a client. This requirement on such an emergency response center creates difficulties for prior art systems. For example, in traditional relational database systems, any input to the system will change the internal state of the system. If two sites become disconnected, independently modify the same data records, and then become connected again, it is impossible to determine which changes are more important and should be kept.

For data integrity in a traditional solution, only one data base exists when a transaction is commenced. During the transaction, other people are blocked from writing into the data at the same time. As a result, when a transaction is successfully executed, and the register into which data is written is read, there is an assurance that the transaction actually occurred, and that the read is based on at least that transaction. However, if an unexpected exception occurs, the entire transaction is canceled. With distributed system that guarantee is not upheld. In addition such solutions do not scale well.

According to embodiments of the invention, administration of a private response center is performed using an event-based model. For the purposes of this disclosure, an event is any detected signal, measurement, or change in state that has already happened in a specific place at a specific time. Examples of events may include, without limitation:
a client updates his or her profile information;
a position fix is received from a client's cellular phone or other communication device;
a client calls the private response center, to request assistance or for another purpose;
a new account is created for a new client of the private response center;
a payment is received from a client for application to the client's bill;
a call from a client is disconnected;
an incident is marked as closed;
a client or other user interacts with a website of the private response center operator;
a customer service representative enters notes about a call from a client;
a user leaves or enters a pre-defined geographic area;
a biometric or environmental change has been sensed by the client's cellular phone or other communication device;
a client is close in proximity to a pre-identified device type, storefront, sensor, or other object; or
an event has occurred via the user's device, such as a monetary transaction, a location lookup, an address lookup, a database access, or text message creation or view.
   Many, many other kinds of events may be envisioned.

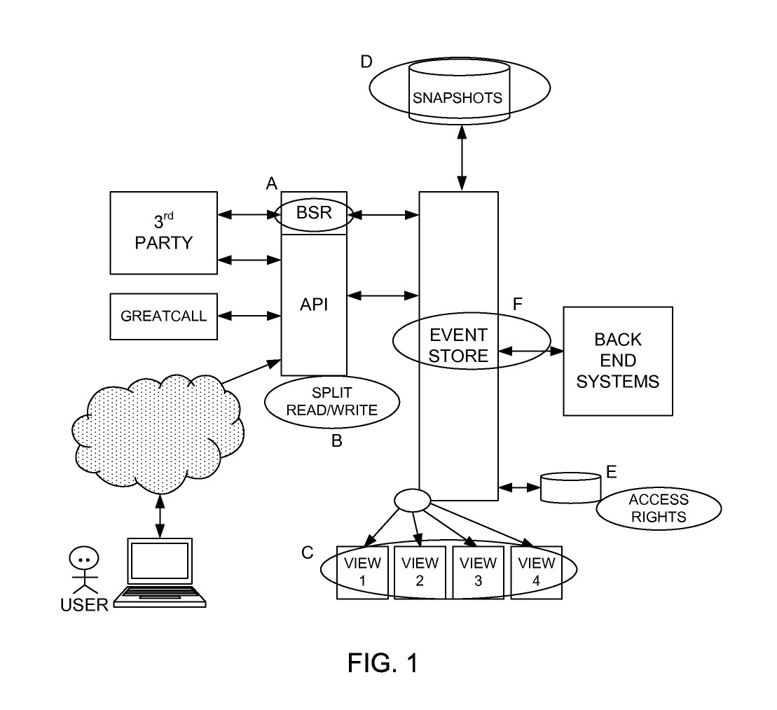

FIG. 1 shows a simplified schematic of a system according to embodiments of the invention. Preferably, a record of every detected event is stored in an event store (F), and events are never deleted or modified once stored. For example, if a client moves and updates his or her profile information, an event is stored, documenting the move. If the client moves again to yet another address, yet another event is stored, and the previous event is not deleted. Thus, the system provides a complete history of events that have occurred since its initialization in a non-hierarchical list. It will be appreciated that the event store is also not a relational database. All events may be typed and may include an event identifier, an identification of the event source, a time stamp, a version number, and a description of the state change documented by the event.

Events may be received relating to a large number of clients. The current state of the client base is thus the accumulated result of the events that have occurred. For example, the current balance of a particular client's account may be considered to be the state of the account, but the balance is the result of all of the billings and receipts attributed to that account since its establishment. Because every event (change in state) is recorded, the state of the account (and thus the entire client base) can be reconstructed for any time for which event data is available.

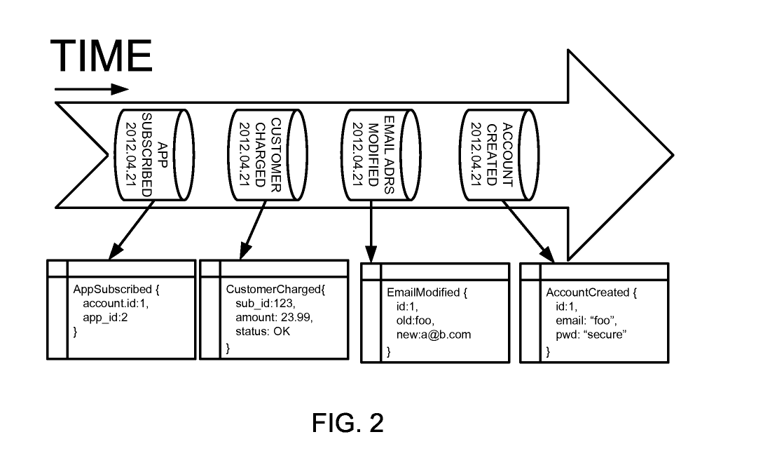

FIG. 2 illustrates a visual representation of a system as a sequence of events, in accordance with embodiments. Events may be stored according to a particular data structure, one example of which may be expressed in pseudo notation as follows:

```
event {
      id: <string>,
      source: “”,
      type: “”,
      timestamp: “”,
      version: “”,
      binary: [ ]
}
```

In this example structure:
Event.id is a guide generated by the detector and is what the system will use to determine identity.
Event.source is a string defined by the role that detected this event.
Event.type is a string of up to 512 characters indicating the event type. The type follows a metasyntax used by the CLR specification. EBNF (Extended Backus-Naur Form) for this syntax is available. The syntax allows an event streams to be formed with hierarchical granularity levels.
Event.timestamp: The UTC time on the clock of the machine that is writing the event to durable storage, this is the default ordering.
Event.version: Version of the event.
Event.binary: An array of bytes used to store a serialized object containing only the state change (diff) corresponding to this event.

An example of this form is provided below.

General Form: [Org Name].[Bounded Context(s)].[Event Name] Actual: GreatCall.Cloud.Sms.Inbound.SmppMessageReceived

This allows a chain of projections each receiving only the messages they will need for their given concern or projection task. In this example the following streams could be established:
All GreatCall events
Any Event pertaining to SMS
Any Event pertaining to Inbound SMS
The event that is recorded when a new smpp message has been detected.

The system may operate in both isolation and in connected states. In isolation, a data storage node on local infrastructure has an up-to-date copy of all information in the system that has been synchronized across all data storage nodes at all sites plus all locally stored data. In connected mode, information that has been stored locally is made available and synchronized across all data storage nodes at all sites, leading to eventual global consistency across all sites. Though synchronization may not be immediate, all sites will eventually become synchronized, and scalability is unlimited. In many embodiments, this is an acceptable tradeoff. If a user writes to a data store and reads from same data store, the user is guaranteed that the information read will reflect the previous write. The user is also guaranteed that the other data stores will also receive the written information.

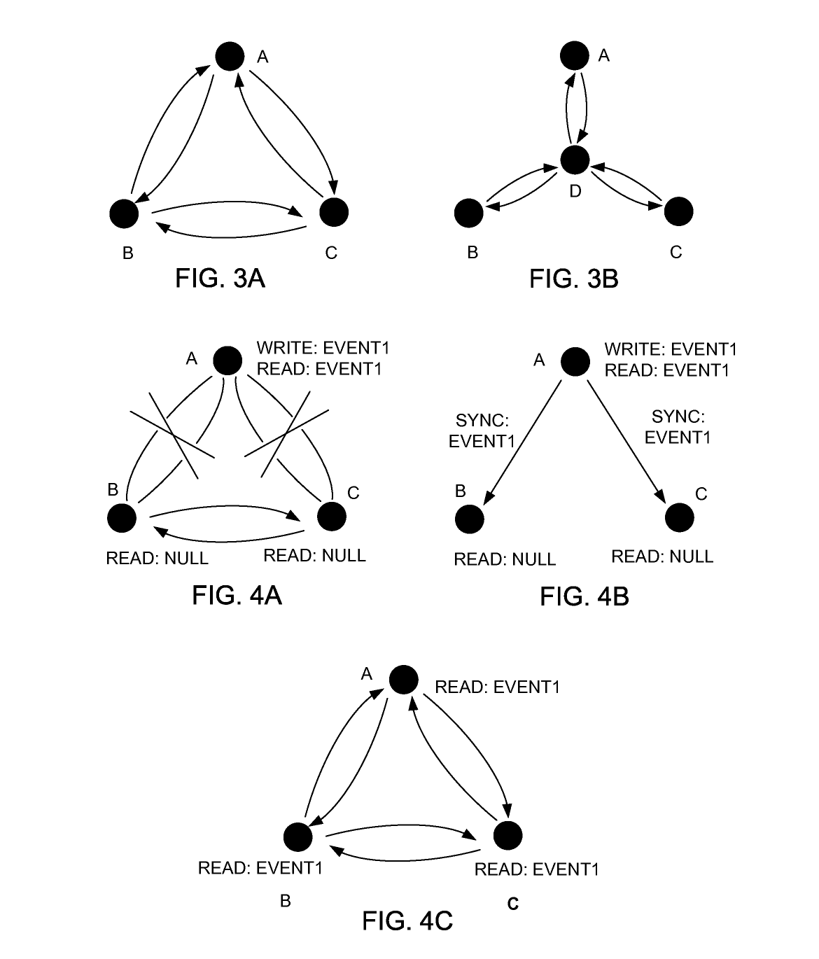

FIGS. 3A and 3B illustrate two example arrangements of distributed storage, according to embodiments of the invention. Distributed storage may provide a benefit in data integrity, as data may be stored at multiple geographically-dispersed locations. In FIG. 3A, nodes A, B, and C communicate on a peer-to-peer bases. For example, node A may be at a central office location of a private response center, and nodes B and C may be located at geographically-dispersed call centers. Any number of nodes may be present. In this arrangement, there is no hierarchy of nodes, and synchronization of data is accomplished using peer-to-peer communications. For example, a customer service representative answering a call at a call center associated with node B may enter notes about the call. That information is stored in the event store as one or more events, and those event records are then propagated to the other nodes in due course. In FIG. 3B, one or more special nodes such as central node D route communications between the other nodes.

FIGS. 4A-4C illustrate the concept of eventual consistency, in accordance with embodiments of the invention. FIG. 4A is similar to FIG. 3A, except that communications to and from node A has been lost, for example due to a network outage or the like. Node A can still write and read new events to the event store, but because communications have been interrupted, the newly-written event records are not available immediately at nodes B and C. In this state, node A is considered to have local consistency. That is, once a new event is persisted to storage, any reads will reflect the new event. However, the system is not globally consistent, in that the new event has not been propagated to other nodes, and reads at the other nodes will not reflect any effects of the new event.

FIG. 4B illustrates the system of FIG. 4 once connectivity has been restored. Once the system recognizes that communications are once again available, it synchronizes the data using peer-to-peer messages. In the example shown, the new event stored at node A is propagated to nodes B and C. FIG. 4C illustrates the system after synchronization is complete. Reads performed at any node will now reflect the effect of the new event, and global consistency has been achieved. In this manner, the system will eventually become consistent after network outages, writes of new events, and the like.

Because events are always added to an event-based system, performance issues may arise as the event store grows. Also, many queries to the system result from different components accessing the same data stream, for example when a user calls in and is connected to an agent, and the telephone caller identification is used to load the user profile. In addition, location updates come in from the phone through a different channel and are inserted into the data stream and data is linked in real time. Events such as answer call, additional location update events, agent notes, map updates, points of interest, and additional information queries are updated every few seconds. In a simplistic event-based system, any time an application or user requests information, all dynamic events have to be scanned to ensure that the only events associated with the current incident are pulled. These are expensive queries both in terms of time and data required. In embodiments of the present invention, the system includes optimizations to address these issues for improved performance.

In some embodiments, the system may periodically construct snapshots of the state of the client base or aspects of it to facilitate reconstruction from known waypoints. For example, the balance of each user's account could be recorded monthly or quarterly, so that reconstructing the current balance may need only start with the most recent snapshot and excessive recalculation can be avoided. Of course, because all events are recorded, reconstruction could start from an earlier snapshot or event from account inception, if desired.

In addition, the system may automatically identify incidents. An incident is a group of events that belong together based on a criterion. For example, in the context of a private response center (PRC), an incident could be a set of related events relating to a particular client call, such as a record of the incoming call, any location updates received from the caller's phone, PRC notes, a record of the time the call ended, a record of the final disposition of the incident, and other related events. Since incidents are both dynamic and frequently queried, as the system scales, performance issues can result where event queries dominate system processes. By automatically identifying incidents, incidents can be automatically partitioned into a different location for quicker access. However, since all events are still written, if something changes or if the right incident grouping is not identified, a complete history of all events is available to recreate and fix incidents as necessary.

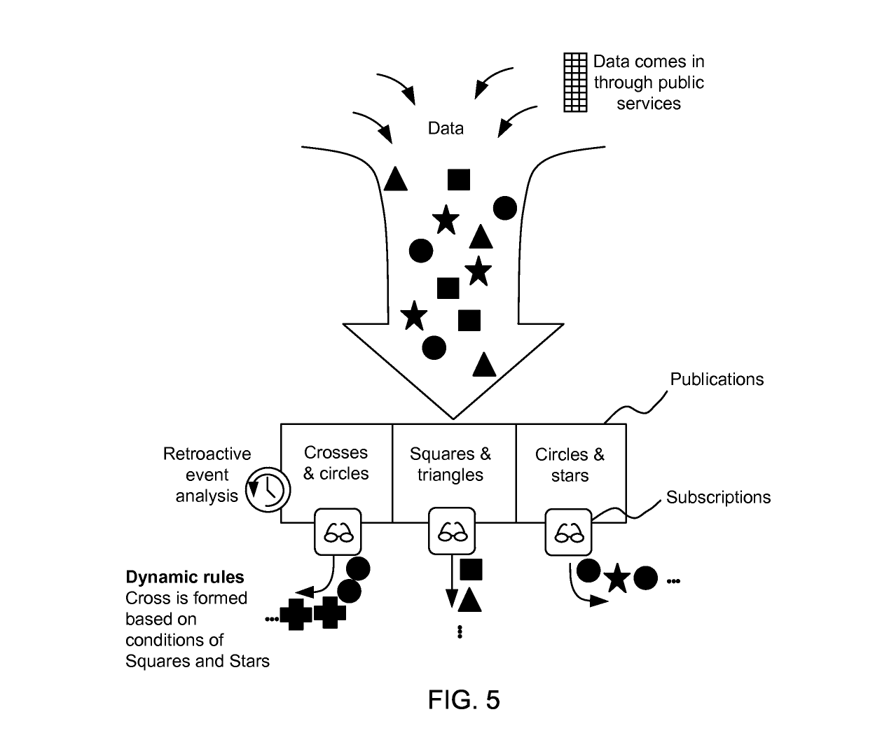

FIG. 5 illustrates another conceptual view of a system in accordance with embodiments of the invention. In FIG. 5, the shapes of data (squares, triangles, circles, stars) entering the system represent different kinds of data, for example events having different types. For example, squares may represent events affecting clients' profiles, triangles may represent events affecting users' accounts, circles may represent geographical locations reported by clients' phones, and stars may represent calls to the service from clients. The various subscriptions have requested different views of the stored information, which are provided by the publications. For example, location information may be provided to a customer service representative when a client calls the private response center (circles and stars). Client account and profile information (squares and triangles) may be used to generate a marketing plan based on client location. In the third example shown above, a new kind of information (crosses) is generated from the event store data. For example, phone geographical location (circles) may be analyzed to detect patterns in the theft of phones (crosses).

Event information can affect different views provided to different subscribers. For example, updates of client profiles will affect the client profiles when viewed by customer service representatives when answering client calls, and may also affect statistical reports generated for marketing purposes, showing statistical information about the client base. Views are not limited to customer service representatives. A third party company other user may be granted access rights through enabling them to generate and view similar reports.

Different parts of the organization may be interested in different aspects of the state of the client base. For example, a billing department may need to know each client's account balance owing so that regular bills can be sent to clients, but the billing department may not need to know how many calls a particular client made to the service during the billing period. On the other hand, the company's information systems department may wish to know how often on average clients call the service, in order to plan for future infrastructure enhancements, but for that purpose does not need to know any particular client's account balance. In another example, user may be a relative of a client and need to view historical location information of an elderly parent, but not need to view the payment history on the parent's account.

In order to meet these diverse needs for information, the system may utilize a publication/subscription method. Particular users may define “subscriptions” that define views (C) of the stored event data or the current system state. The system then generates “publications” that provide the requested views to the requesting users. Some publications may simply include the current state of some aspect of the system, for example a client's current account balance. Other publications may include sequences of events that a user can inspect to determine how a particular state was reached. For example, when a client calls the private response center, the client's phone or other communications device may provide an indication of its geographical location, and that location may be provided to the customer service representative answering the call. That is, the state of the client's location is provided. However, another subscription may request the history of all locations reported by the client's phone, for example to assist the client in locating a lost or stolen phone.

In another aspect, the system includes user definable application programming interface (API) extensions (A), enabling users to customize subscriptions easily. Custom user settable access rights (E) may also be provided for privacy control.

In some embodiments, the system incorporates a novel “split read/write” function (B). In traditional systems data can be written, queried, or read; however, the data is written to and read from the same location. In such a system, the more the system writes to a location, the worse the reading performance gets. For an event driven system, these performance issues are compounded. For example, in order to derive the current state, a simplistic system would have to run through every event in real time and do any necessary calculations. In an emergency system, any delays could be catastrophic, and any unnecessary real time calculations will eventually lead to performance or scalability issues, especially for more complicated data models. A split read-write architecture helps alleviate this situation. Anytime a write happens, the system dispatches the update to multiple listeners and updates the read view at the time of the write. With this method, each view can be updated in real time without the inherent bottleneck created by traditional systems.

In some embodiments, the system supports event persistence. The system can be brought down at any point in time during its operation. If that happens before an event is persisted, that event will be lost. Since events are the source of everything that happens within the system, the architecture does not let them affect the state of the system at any time before they are saved in persistent storage. Otherwise the system could be left in an inconsistent state. On the other hand, if an event is saved in persistent storage, other parts of the system can always be made consistent with it by reading that event from storage and applying it.

A system supporting event persistence may be built on two assumptions which always hold true:
1. If an event was persisted successfully, the state of each and every part of the system will eventually become consistent with that event.
2. If an event was NOT persisted successfully, the state of the system will NOT be affected by that event.
   For optimization purposes, events that occur together in time may be saved within a single aggregate root as “event batches”.

Various methods may be employed for ensuring that the system is consistent with the events in persistent storage. In some embodiments, the system uses the idea of “lazy consistency” when working with aggregate root snapshots. In this type of system, each batch of events is persisted with a version number. Each aggregate root snapshot also maintains a version number indicating the latest event batch which has been applied to it. If the version number of the snapshot is less than the version number of the latest corresponding event batch in persistent storage, it means that the snapshot is not consistent with the events. To ensure that the snapshot is consistent with the event store, the system applies any new events to the snapshot in conjunction with constructing the snapshot. This way the system guarantees that any reads, writes or related operations against the snapshot are executed against a view of the data that is consistent with the event store. This “lazy” algorithm can be implemented using a DistributedStore and a DistributedUnitOfWork.

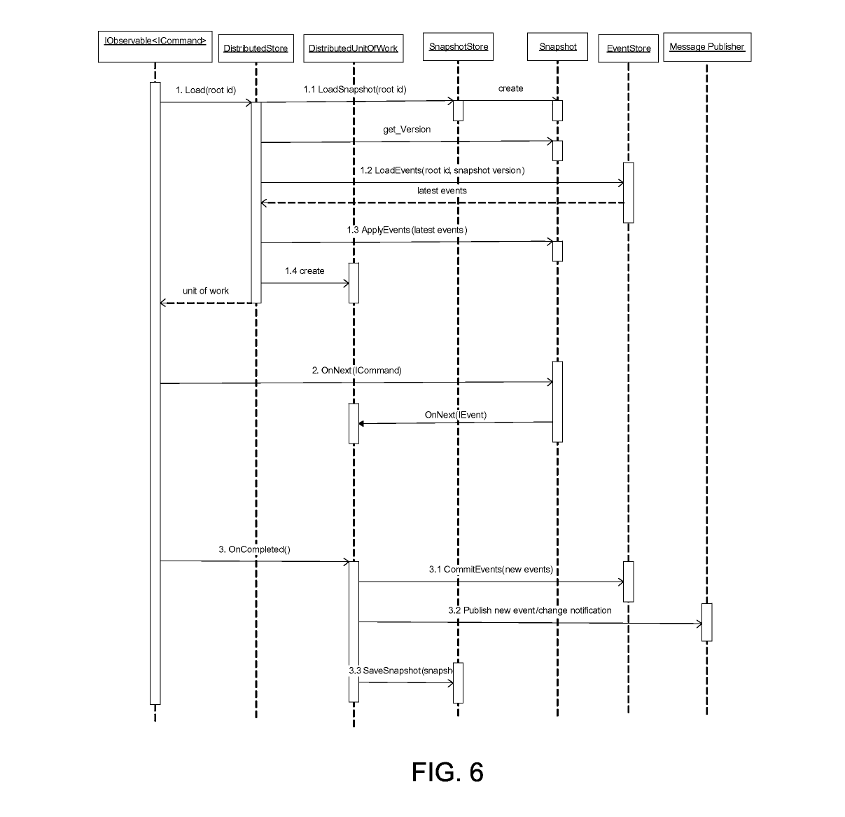

FIG. 6 shows a sequence diagram illustrating in more detail how two objects work to provide consistency, in accordance with embodiments of the invention.

When a client needs to read or write to an aggregate root:
1. A Data Service loads a DistributedUnitOfWork from the DistributedStore:
   1.1. The current snapshot of the Aggregate Root and its version are loaded from the SnapshotStore.
   1.2. Any events with a higher version number are loaded from the EventStore.
   1.3. The new events are applied to the Snapshot consecutively.
   1.4. The updated snapshot is wrapped in a DistributedUnitOfWork.
2. The commands, if there are any, are applied to the in-memory snapshot.
3. The DistributedUnitOfWork is saved:
   3.1. First and foremost, any new Events are saved to the EventStore.
   3.2. If there are new Events, a message is send out to alert other parts of the system which may need to know about the events.
   3.3. Eventually the Snapshot is also persisted.

If the process fails any time before or during step 3.1 then the entire operation fails, no change in state occurs and nothing is persisted. If the error occurs after step 3.1, the event is successfully persisted. This results in a temporary inconsistency. However, this inconsistency is automatically rectified the next time a client tries to perform an operation against the same aggregate root. Note that the entire sequence 1.1 through 3.1 occurs synchronously. This way the system guarantees that there will be no lost writes and the client will never receive a false “Success” response if any of the steps up to 3.1 fails.

In some embodiments, the system incorporates an “eager consistency” form of consistency modeling that is well suited for a concurrent programming. In other words, as soon as there are writes to the queue, the system applies them to the views that are interested. As soon as a read happens that affects one of the entities that may have a write entered into the queue, those writes are selected and applied. This method maintains a balance between computing every time a view is queried and writing every single write immediately to all views that might view it later. This modeling enables the system to tune snapshot creation and storage individually, and not have to apply system-wide rules.

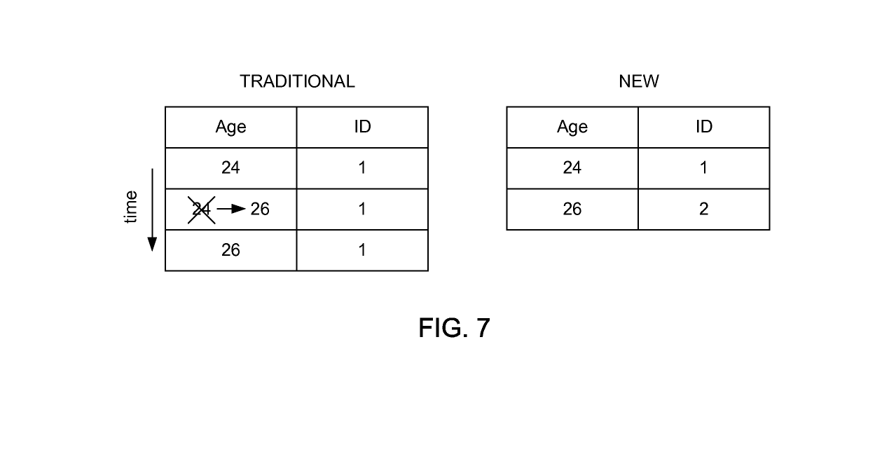

FIG. 7 further illustrates the event-based aspect of the system. In the traditional system, a client's age may have been updated by simply replacing a prior age with a new age in a database. In the “new” system, an event is recorded, documenting the change in the client's age. The prior event that initialized the age entry is not deleted. Thus, the history of the change is also recorded, such as the date on which the change was made. Organization of information in this fashion may be useful to reduce backup requirements, to enable auditing, self-correcting capabilities, and parallel data models.

Embodiments of the invention may also provide advantages in data backup. The continued growth and need for big data will continue to necessitate copy and back up of data, especially since traditional data models require data to be copied so as to be modified. Embodiments of the invention provide an advantageous architecture which has the ability to create views and analytics without the need to move data to the cloud. Other advantages to this architecture include the ability to be selective about only backing up records that get queried the most, as well as dynamically identifying which records get queried based on pattern recognition.

By providing only the raw data needed to recreate all events, embodiments of the invention may reduce backup needs dramatically, despite the fact that it is a large distributed system that doesn't run on one machine, and despite the fact that views can get corrupted. Corrupted views can be destroyed to last known snapshot and recreated from that point. An advantage of this invention is that views are side effects, not the real data.

Thus as stated, this system has repeatability built into the system. This repeatability can manifest itself in the ability to “replay” events. This capability may be useful, for example, to diagnose problems in the system or resolve client issues. In another application, new event processing algorithms may be tested on old event data before implementing them “live.” The ability to replay events provides a built-in auditing capability, as the history of the client base is available in great detail. This feature also has benefits when concerns about liability surface. The architecture will provide high levels of assurances that data is not corrupted and is not faked. If there were an issue, system administrators can go back and recreate what happened in the past without doubt. Since events can only be added, not modified or deleted, this security is possible. For example, if a user were to add himself or herself as an emergency contact, but input the incorrect phone number leading to an issue with the PRC contacting an incorrect person during an emergency, a system administrator can see what has transpired, even if the number were to be later updated. In prior art systems, administrators would have to get that information from outside of the system through logs which would have to be monitored and kept track of separately.

An architecture according to embodiments of the invention may also provide for a self-correcting function. For example, if a calculation 1+1+1+1, outputs ‘5’ as an answer, the system would not know if answer was correct unless it knew how many digits were added. On the other hand, if all inputs are known, the system could verify that it was in the correct state. In some embodiments, a separate process can be run that continually replays all events, and checks all the states. If any replay does not result in a match to the current state, adjustments or corrective actions could be applied. The separate process could be a built-in test. For example, since it is known that 1+1+1+1=4, that equation can be inserted into the process to confirm that the system is fully functional.

Given a finite set of events, in some embodiments a the correct state of the system at any given time t can be verified as a set comprehension:

{f(e) [symbol] e|eεEₜf(e) [symbol] bool}

where
E=The set of all input events in a reactor system's event store. (For infinite sets (no specified window of time) it is assumed t initial=first event and t final is time of last event).

e=a single event
f(e)=>e: The projection (output) function.
f(e)=>bool: This predicate (filter) function.

As a practical example, the system may self correct for profile updates. For example, it could capture every time a person adds deletes, or modifies contact in profile. The system could have an automated process that pulls only those modifications and recalculates them on a different database in isolation and compares that with what the original output. If they are not the same, the system would consider this one accurate, and can apply the result of a differencing function to make the output more accurate.

The system may also provide for parallel data models, through enabling different views on the same data without modifying and copying the data. The system enables different views on the same data, meaning different views are available without having to copy and modify the data. In traditional systems, separate logs are necessary to monitor historical data, since traditional data systems only store the current state and not how that state was arrived at. The system thus provides for a single source of truth via all events that ever happened.

An advantage to having different events and different views and all events available to the system is that reporting requirements can be developed after the fact. In traditional systems analytics requirements must be defined up front in order to store those events. If those requirements are added at a later time, at that point, logs or transactional records must be actively identified and stored before those analytics requirements can be met. Requirements must be reverse engineered from the operational database. Replication or some other way of obtaining a real time feed must be established and data from those changes must be stored. In addition, as the list of captured items grows, a method of managing and extracting the data into useful information must be developed. In accordance with some embodiments of the invention, views can be created in real time, which output the necessary reporting view. In this way, instead of changing front end systems to accommodate analytics, back end data can be analyzed to derive what is happening at the front end. By flipping model around and storing just events, having operational database use views that are dynamically created, work can be performed after the fact.

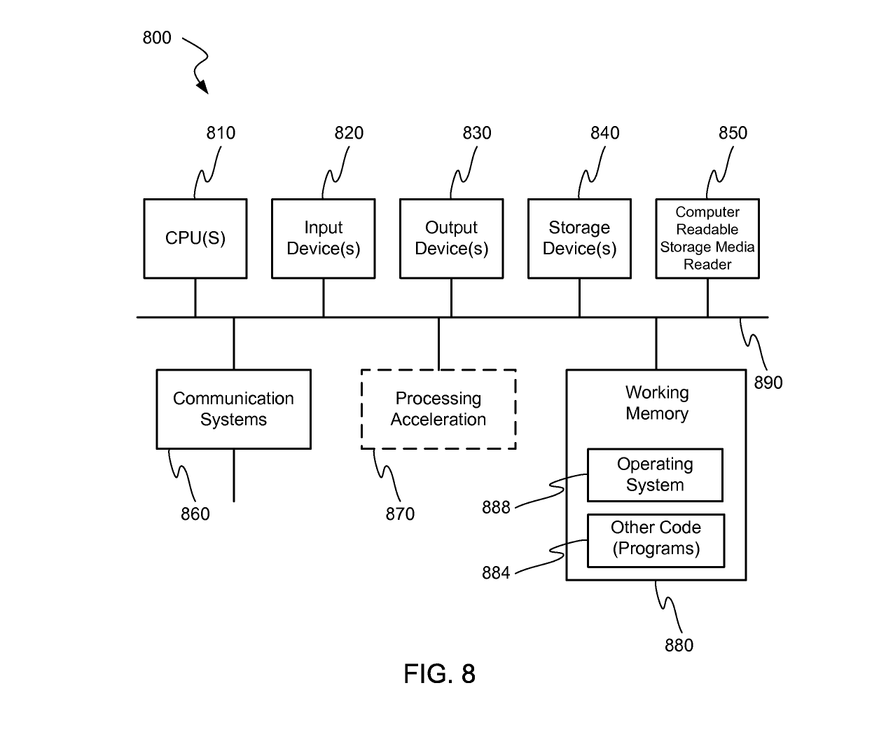

FIG. 8 is a block diagram illustrating an exemplary computer system 800 usable in embodiments of the invention. This example illustrates a computer system 800 such as may be used, in whole, in part, or with various modifications, to provide the functions of one of nodes A, B, C, or D, and/or other components of the invention. Multiple computer systems such as computer system 800 may be used in cooperation. Components of the one or more computer systems may be collocated or widely distributed.

Computer system 800 is shown comprising hardware elements that may be electrically coupled via a bus 890. The hardware elements may include one or more central processing units 810, one or more input devices 820 (e.g., a mouse, a keyboard, touchscreen etc.), and one or more output devices 830 (e.g., a display device, a touchscreen, a printer, etc.). Computer system 800 may also include one or more storage devices 840. By way of example, storage device(s) 840 may be disk drives, optical storage devices, solid-state storage devices such as a random access memory (“RAM”) and/or a read-only memory (“ROM”), which can be programmable, flash-updateable and/or the like.

Computer system 800 may additionally include a computer-readable storage media reader 850, a communications system 860 (e.g., a modem, a network card (wireless or wired), an infra-red communication device, Bluetooth™ device, cellular communication device, etc.), and working memory 880, which may include RAM and ROM devices as described above. In some embodiments, computer system 800 may also include a processing acceleration unit 870, which can include a digital signal processor, a special-purpose processor and/or the like. Working memory 880 may hold instructions that, when executed by CPU(S) 810 cause computer system 800 to perform aspects of the claimed invention.

Computer-readable storage media reader 850 can further be connected to a computer-readable storage medium, together (and, optionally, in combination with storage device(s) 840) comprehensively representing remote, local, fixed, and/or removable storage devices plus storage media for temporarily and/or more permanently containing computer-readable information. Communications system 860 may permit data to be exchanged with a network, system, computer and/or other component described above.

Computer system 800 may also comprise software elements, shown as being currently located within a working memory 880, including an operating system 884 and/or other code 888. It will be appreciated that alternate embodiments of computer system 800 may have numerous variations from that described above. For example, customized hardware might also be used and/or particular elements might be implemented in hardware, software (including portable software, such as applets), or both. Furthermore, connection to other computing devices such as network input/output and data acquisition devices may also occur.

Software of computer system 800 may include code 888 for implementing any or all of the function of the various elements of the architecture as described herein.

A system in accordance with embodiments of the invention may conveniently be implemented in a cloud-based environment, for example the Microsoft Windows Azure platform, offered by Microsoft Corporation of Redmond, Washington, USA.

While the principles of the disclosure have been described above in connection with specific apparatuses and methods, it is to be clearly understood that this description is made only by way of example and not as limitation on the scope of the disclosure.

What is claimed is:

1. A system for managing operational records, the system comprising:
one or more processors;
memory holding instructions executable by the one or more processors;
distributed storage holding a plurality of event stores storing records of events; and
one or more electronic communication links between locations at which the event stores are stored;
wherein the instructions, when executed by the one or more processors, cause the system to
receive a request for a view of a state of the system; and
construct the view from the records in at least one of the event stores.

2. The system for managing operation records of claim 1, wherein the events include calls by clients of a private response center requesting assistance from the private response center.

3. The system for managing operation records of claim 1, wherein the instructions, when executed by the one or more processors, further cause the system to synchronize the event stores to reflect changes made at one of the event stores such that eventually a view resulting from a request made at any of the event stores will be consistent with a view resulting from a like request made at any other of the event stores.

4. The system for managing operation records of claim 1, wherein upon receipt of a write of a new event record to the event stores, the event is applied to any affected views.

5. The system for managing operation records of claim 1, wherein events are applied to affected views in conjunction with constructing a snapshot of a state of the event stores.

6. The system for managing operation records of claim 1, wherein the instructions, when executed by the one or more processors, further cause the system to construct a snapshot of a state of the event stores.

7. The system for managing operation records of claim 6, wherein the instructions, when executed by the one or more processors, further cause the system to construct the requested view in relation to the most recent snapshot.

8. A method of maintaining records of events, the method comprising:
maintaining in distributed storage a plurality of computerized event stores storing records of events in a non-hierarchical list;
constructing views of the records in the event stores in response to view requests;
synchronizing the event stores, via electronic messages sent over a data network, to reflect changes made at one of the event stores such that eventually a view resulting from a request made at any of the event stores will be consistent with a view resulting from a like request made at any other of the event stores.

9. The method of claim 8, further comprising applying an event record to an affected view upon receipt of a write of the new event record to the event stores.

10. The method of claim 8, further comprising periodically preparing a snapshot of the state of an aspect of the event records in the event stores.

11. The method of claim 10, further comprising applying an event record to an affected view in conjunction with constructing a snapshot of an aspect of the event records in the event stores.

12. The method of claim 8, further comprising auditing a state of the event stores by reconstructing the state from event records in the event stores.

13. The method of claim 8, further comprising:
receiving event records independently at one of the event stores during a time when network connectivity is lost between the event stores; and
when network connectivity is restored, synchronizing the event records in the event stores.

14. The method of claim 8, wherein constructing views of the records in the event stores comprises constructing a view that includes a listing of event records from the event stores.

15. The method of claim 8, wherein constructing views of the records in the event stores comprises constructing a view that includes state information derived from event records in the event stores.

16. The method of claim 8, further comprising grouping related events in the event stores into incidents.

17. A system for managing records, the system comprising:
one or more processors;
memory holding instructions executable by the one or more processors;
distributed storage holding a plurality of event stores storing records of events in a non-hierarchical list; and
an electronic network connecting the distributed event stores;
wherein the instructions, when executed by the one or more processors, cause the system to
receive a request for a view of a state of the system;
construct the view from the records in at least one of the event stores;
receive at one of the event stores a record of a new event; and
synchronize the event stores to reflect the new event such that eventually a view resulting from a request made at any of the event stores will be consistent with a view resulting from a like request made at any other of the event stores.

18. The system of claim 17, wherein the event stores are synchronized upon receipt of the new event record.

19. The system of claim 17, wherein the event stores are synchronized in conjunction with constructing a snapshot of the state of an aspect of the event records in the event stores.

20. The system of claim 17, wherein no event records are deleted from the event stores.
